(19) United States
(12) Patent Application Publication
(10) Pub. No.: US 2023/0377385 A1
(43) Pub. Date: Nov. 23, 2023

(54) METHOD FOR VALIDATING SAFETY PRECAUTIONS FOR VEHICLES MOVING IN AN AT LEAST PARTIALLY AUTOMATED MANNER

(71) Applicant: Robert Bosch GmbH, Stuttgart (DE)

(72) Inventors: Andreas Heyl, Weil Der Stadt (DE); Farzaneh Ghanbari Milani, Korntal-Muenchingen (DE); Markus Schweizer, Vaihingen/Enz (DE); Peter Munk, Renningen (DE)

(21) Appl. No.: 18/179,562

(22) Filed: Mar. 7, 2023

(30) Foreign Application Priority Data
May 23, 2022 (DE) 10 2022 205 138.6

(51) Int. Cl. G07C 5/08; G07C 5/02; G07C 5/00

(52) U.S. Cl. CPC G07C 5/0808; G07C 5/02; G07C 5/008

(57) ABSTRACT

A method for validating safety precautions for vehicles moving in an at least partially automated manner, based on triggering events and safety metrics. The method includes: receiving, from one or from each of a plurality of vehicles moving in an at least partially automated manner, operating data of the vehicle present and/or recorded at the time, regarding the triggering event and/or safety metric, if at the time in the vehicle, one or at least one of a plurality of triggering events associated therewith is met and/or one or at least one of a plurality of safety metrics associated therewith exceeds or falls below a threshold value; analyzing the received operating data, correlations of triggering events, occurring at more than a predetermined frequency, and/or safety metrics being determined with respect to static and/or dynamic vehicle data of the one or of the plurality of vehicles; and providing the determined correlations.

### CROSS REFERENCE

The present application claims the benefit under 35 U.S.C. § 119 of German Patent Application No. DE 10 2022 205 138.6 filed on May 23, 2022, which is expressly incorporated herein by reference in its entirety.

### FIELD

The present invention relates to methods for validating safety precautions for vehicles moving in an at least partially automated manner, and to a computing unit and a computer program for carrying them out.

### BACKGROUND INFORMATION

In various areas, vehicles that move in an at least partially or even fully automated manner can be used. For example, vehicles for passenger and goods transportation on the road are becoming more and more automated, all the way to an autonomously driving vehicle. However, vehicles moving in an at least partially automated manner are, for example, also used in factory or plant environments, for example also as robots. Depending on the area of use and/or the application, the use of such vehicles can be safety-critical. For example, the safety of people in such a vehicle must be ensured at all times, if possible.

### SUMMARY

According to the present invention, methods for validating safety precautions for vehicles moving in an at least partially automated manner are provided as well as a computing unit and a computer program for carrying out the same. Advantageous embodiments of the present invention are disclosed herein.

The present invention relates to vehicles moving in an at least partially or even fully automated manner, such as vehicles for passenger and/or goods transportation on the road, in factory or plant environments, or robots. As mentioned, the use of such vehicles may be safety-critical depending on the area of use and/or application.

In particular, the present invention relates to validating safety precautions for vehicles moving in an at least partially automated manner, namely based on triggering events and safety metrics. A triggering event shall define one or multiple predetermined conditions for one or multiple vehicle parameters and/or environmental parameters that are at least partially detectable by means of one or multiple sensors of a vehicle moving in an at least partially automated manner. In this way, for example, it can be detected in a vehicle whether a (possibly potential) safety-critical situation exists, and measures, e.g., braking of the vehicle can, for example, be taken if necessary.

A safety metric shall define a metric that determines (or measures) values for one or multiple vehicle parameters and/or environmental parameters in a vehicle moving in an at least partially automated manner, during operation of the vehicle and compares them to one or multiple threshold values (e.g., upper and/or lower threshold value).

In particular, the ISO PAS 21448 standard is also used. This standard defines, for example, a so-called operational design domain (ODD) as any possible conditions, applications, constraints, and situations that an autonomous system or vehicle, or an autonomous function thereof, can safely handle without driver (or user) intervention. Typical ODD factors include time of day, weather, traffic, and road conditions. In order to release the application of an autonomous system or vehicle (or the function thereof), limits of the ODD or of ODD factors must be defined, which must be given for a correct automated function. Limits can be, for example, that the automated function considered is allowed only in daylight (limit based on the ODD factor “time of day”) and in dry weather (limit for ODD factor “weather” or “road condition”) because, for example, video-based sensor technology is used. A function may also be allowed, for example, only on highways (limit for ODD factor “road type”).

ISO PAS 21448 defines a scene, e.g., as a characteristic of the ODD at a fixed time, e.g., at a fixed time in rain with a lot of traffic on a highway with a curve radius of 3° and outside of a tunnel. A scenario, on the other hand, is a description of the temporal development between a plurality of scenes.

ISO PAS 21448 also defines a so-called triggering event as specific conditions of a scenario in which the safe behavior of the system or of the vehicle within ODD is also potentially at risk even without the existence of internal faults, i.e., for example, when exiting a tunnel against oncoming lights or backlight and a subsequent sharp turn. If these triggering events are known, the system or the vehicle may be designed such that safe operation even in these situations continues to be ensured. In order to detect and evaluate the potential triggering events, various scenarios must be reconstructed based on the triggering factors, such as weather conditions, time of day, road profile, and other road users. The mentioned triggering event may, in particular, be or include such a triggering event.

A triggering event shall in particular also include its technical description, with which a vehicle can determine by means of its sensors whether it is currently in a triggering event or whether such an event is met, i.e., whether the following applies, for example: the time is in a predetermined range, a rain sensor and an internet service report rain, an HD map and a GPS signal provide a position on a highway as the current position, radar and camera detect many (e.g., more than a predetermined number of) further road users.

In the UL4600 standard, a so-called safety performance indicator (SPI) is defined as a safety-related metric that is determined or measured in the vehicle at run time, i.e., during operation. Such an SPI is, for example, the time to collision (TTC), i.e., a time up to a (hypothetical) collision with an obstacle that is continuously determined in the vehicle in order to derive driving actions therefrom. For example, if a particular TTC is undershot, a corresponding braking operation is initiated. One or multiple (additional) threshold values can now also be defined for each SPI, relevant vehicle and environmental data being sent to an evaluation system or an evaluation site, such as a server, when said threshold values are exceeded or undershot. The aforementioned safety metric may, in particular, be or include such an SPI, in particular with one or multiple such threshold values. Other examples of SPI include the brake threat number (BTN) or the steering threat number (STN). Both metrics are based on vehicle acceleration. The STN assesses the risk of a steering maneuver for collision avoidance while the BTN assesses the risk of a braking maneuver for avoiding a collision. Additionally, in-vehicle metrics, for example, the correct classification of objects in a camera path or the frequency of triggering a safety mechanism, may be used as SPI.

In particular, but not only, in vehicles moving in an at least partially automated manner in complex environments such as road traffic, many different triggering events are possible and also necessary to be able to cover as many safety-critical situations as possible or all safety-critical situations. However, as has been found, it is difficult to list all or sufficiently many triggering events, in particular also in full, i.e., with all relevant conditions. In the context of the present invention, this may be done using field data.

For this purpose, according to an example embodiment of the present invention, operating data of the vehicle present and/or recorded at the time, in particular regarding the triggering event and/or the safety metric, are received from one or from each of a plurality of vehicles moving in an at least partially automated manner, if at the time in the vehicle, one or at least one of a plurality of triggering events associated therewith is met and/or one or at least one of a plurality of safety metrics associated therewith exceeds or falls below a threshold value (associated with them). Thus, these operating data can be transmitted from the relevant vehicle to an evaluation system or an evaluation site, such as a server or other computing unit (also into the so-called cloud).

These operating data may comprise, for example, for at least one, preferably each, sensor of the vehicle, a result of the last sensor self-calibration and the current sensor data. Likewise, internal states of the vehicle, e.g., a detected environment, or also current values of at least one safety metric, preferably all safety metrics, come into consideration, for example. Likewise, the operating data may comprise the triggering triggering event, if applicable. Also possible are the current values of at least one triggering factor, preferably all triggering factors, used to determine whether a triggering event is met, e.g., speed, position, time of day, weather at the time.

According to an example embodiment of the present invention, the operating data received are then analyzed, e.g., at the evaluation site. Here, correlations of triggering events, occurring at more than a predetermined frequency, and/or safety metrics are determined with respect to static and/or dynamic vehicle data of the one or the plurality of vehicles moving in an at least partially automated manner. These correlations may then be provided, e.g., for further processing and/or measures, as explained below. For example, new triggering events can be determined, which can then also be transmitted to the vehicles and then be used there, and errors can, for example, also be found in one or multiple relevant vehicles, e.g., in a sensor there.

In particular, the assumption can be made that there is a correlation between triggering events and the safety metrics or the exceeding or undershooting of their threshold values. This correlation may be used to identify new triggering events (if only the threshold values of the safety metrics are exceeded or undershot) or to detect defective sensors or sensor systems in individual vehicles if triggering events are detected but safety metrics are not responding, i.e., if their threshold values are not exceeded or undershot.

In this way, data (the operating data) are transferred from the vehicles to the evaluation site only during or in the event of triggering events or in the event that safety metrics exceed or fall below their threshold values. Thus, only data that are actually relevant to the (safety) development are sent back to the evaluation site for (usually costly) evaluation.

The correlation with exceeding or undershooting the threshold values of the safety metrics can increase the completeness of the triggering events. If more triggering events are known during the development, a vehicle can respond in a safer, more proactive manner and with the appropriate mitigation measures upon detection of a corresponding scene. This increases the safety of the entire vehicle fleet.

Triggering events often also represent the limits of the ODD. By the described procedure, these limits can be defined more precisely and the criticality of these scenes can be determined statistically. The information obtained in this way can successively broaden the limits of the ODD, either by establishing a low criticality in these areas or by specifically implementing mitigation measures (inside or outside the vehicle).

Vehicle-specific abnormalities (so-called outliers) in the data obtained in this way can be used as an input variable for vehicle-specific health monitoring (monitoring whether the vehicle is functional).

The set of correlated data may be used to more accurately identify triggering events. For example, it may be determined more precisely whether a problem is due to a bridge itself or due to the bridge having a certain height and a relative angle to the road. This allows targeted countermeasures to be developed (e.g., marking on a map), which makes the fleet more performant and allows for ODD broadening while maintaining safety.

As mentioned, according to an example embodiment of the present invention, static and/or dynamic vehicle data are used for the correlation; these may in particular be stored in the evaluation site or the computing unit during the technical implementation or may be retrieved from elsewhere. These are technical features for each vehicle of a vehicle fleet. The static (i.e., fixed) vehicle data (so-called basic data) may be vehicle parameters, e.g., weight (with minimum and maximum values), power, powertrain, etc. Equipment features such as LED headlights, active damping, fittings, paintwork, etc. are also possible. Likewise, design parameters, e.g., sensor position and installation direction, as well as hardware and/or software versions of the components of the vehicle, come into consideration.

The dynamic (i.e., variable) vehicle data (or also features) include, for example, a current weight (e.g., dependent on loading and occupants), a current version of a software or function, current limits of the operational design domain (ODD), system parameters set (e.g., these are settings made by the driver/user, such as setting the desired distance to the front vehicle while following (similarly to the so-called ACC or active cruise control), maximum speed specification, selected damper setting (comfort or sporty) and the like), a result of the last sensor self-calibration as well as diagnostic and error memory entries.

With the help of correspondingly extensive, retrievable vehicle data, it is possible to find correlations, e.g., by means of data mining, and to thus draw conclusions about the error causes. An example is that via the technical feature “LED headlights” in combination with the current vehicle weight and a cumulative occurrence of triggering events at night time, inadequate illumination due to excessive load can be inferred.

According to an example embodiment of the present invention, at the evaluation site, the received data are evaluated automatically and underlying patterns (correlations) are detected, e.g., statistically or by machine learning. Conversely, it can be expected that if threshold values for safety metrics are exceeded or undershot, many or all characteristics of a triggering event are met. For example, it can be expected that the safety metrics, in the presence of a triggering event, have already assumed values near or above (or below) the threshold value, i.e., the meeting of a triggering event and the exceeding or undershooting of threshold values of a safety metric are correlated in time. If the two cases occur separately from one another or only one case occurs, it can be investigated based on the transferred vehicle data whether new safety metrics or further triggering events are to be defined.

Based on the transferred vehicle data across the entire fleet, the following information can in particular be statically collected:
A cluster of critical situations in ODD subgroups (the ODD factors, such as time of day, weather, traffic and road conditions, may each have different characteristics, the mentioned ODD subgroups, i.e., for example, the time of day may be categorized as day, night or twilight, the weather as sun, rain, fog, cloudy, etc.), for example specific geographic locations, weather conditions, light conditions, object constellations, spatial proximity of specific objects, time of day, season, etc.
Likewise, a correlation between the exceeding or undershooting of threshold values for safety metrics and the ODD characteristic, e.g., for time to collision (TTC), the value is too small under special bridges. One reason could be that, e.g., the radar sensor identifies the bridge as a vehicle when the road slopes accordingly.
Also, outliers within the vehicle fleet. For example, a single vehicle may be identified that, unlike the remaining vehicles in the fleet, does not exceed or undershoot any threshold values during comparable triggering events. By means of the technical features (static and/or dynamic data) of this vehicle, it is possible, for example, to draw conclusions about sensor errors, assembly errors or incorrect behavior caused by loading. Accordingly, a response can be triggered, e.g., continuous observation, request to visit workshop, or direct shutdown.

According to an example embodiment of the present invention, this information can be used to identify further triggering factors and to define new triggering events that were detected by the exceeding or undershooting of threshold values for safety metrics or by clusters in ODD subgroups, which improves the completeness of the triggering events. For example, a triggering event at a specific geographic location may be defined without additional conditions so that the vehicle fleet is instructed to always deliver data to the evaluation site at this point in order to improve situation recognition by means of the measured values.

A computing unit according to the present invention, e.g., a control unit of a vehicle or a server, is configured, in particular in terms of program technology, to carry out a method according to the present invention.

The implementation of a method according to the present invention in the form of a computer program or computer program product with program code for carrying out all method steps is also advantageous since this results in particularly low costs, in particular if an executing control unit is also used for further tasks and is therefore already present. Lastly, a machine-readable storage medium is provided, on which the computer program is stored as described above. Suitable storage media or data carriers for providing the computer program are in particular magnetic, optical and electrical memories, such as hard disks, flash memories, EEPROMs, DVDs, etc. Downloading a program via computer networks (Internet, intranet, etc.) is possible as well. Such a download can take place in a wired or cabled or wireless manner (e.g., via a WLAN, a 3G, 4G, 5G or 6G connection, etc.).

Further advantages and embodiments of the present invention become apparent from the description herein and the figures.

The present invention is shown schematically in the figures by means of an exemplary embodiment and is described below with reference to the figures.

### BRIEF DESCRIPTION OF THE DRAWINGS

FIG. 1 schematically shows an arrangement with a plurality of vehicles for explaining the present invention.

FIG. 2 schematically shows a sequence of a method according to the present invention in a preferred embodiment.

### DETAILED DESCRIPTION OF EXAMPLE EMBODIMENTS

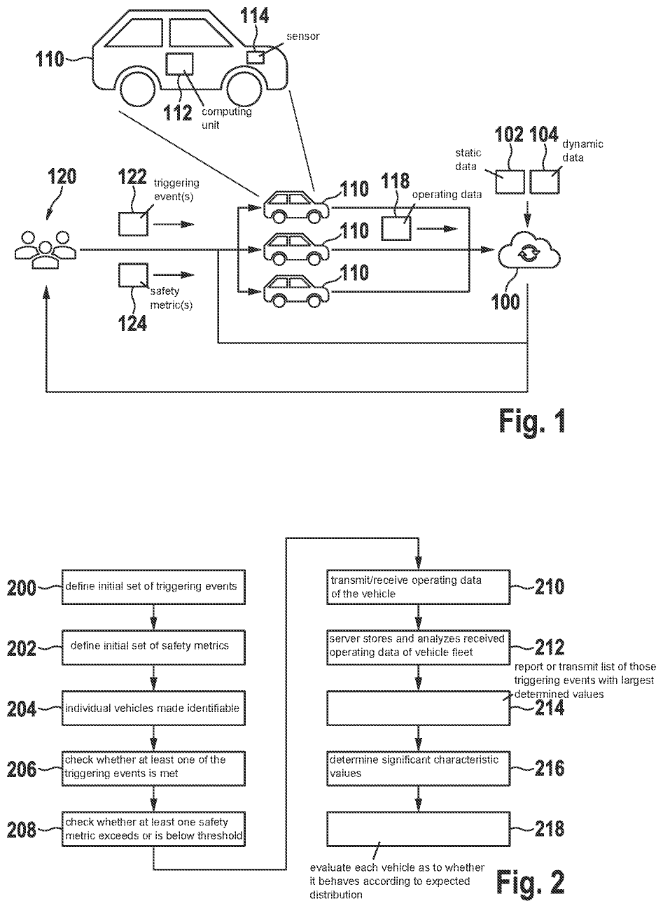

FIG. 1 schematically shows an arrangement with a plurality of vehicles 110 and a computing unit 100 for explaining the present invention. The computing unit 100 can, for example, be a server, possibly also for a so-called cloud, which serves as an evaluation site or evaluation system.

The vehicles are vehicles moving in an at least partially automated manner, e.g., so-called autonomous vehicles. These may be part of a vehicle fleet and may be identical or similar in configuration. It is understood that in practice there will be significantly more vehicles.

One of the vehicles 110 is also shown enlarged, by way of example. This vehicle comprises a computing unit 112 configured as a control unit, as well as a sensor 114, by way of example. For example, the computing unit 112 may read data from the sensor 114 and may also exchange data with the computing unit 100 and/or other communication units via a communications module (not shown). It is understood that the vehicle may comprise further sensors and/or control units. Likewise, the other vehicles 110 have such a control unit and sensors. Furthermore, exemplary persons 120 are illustrated, e.g., developers.

FIG. 2 schematically shows a sequence of a method according to the present invention in a preferred embodiment. Referring to FIG. 1, this exemplary sequence is to be explained below.

In a step 200, an initial set of triggering events 122 can first be defined for the vehicle fleet. This may be done, for example, by developer 120. The triggering events are transferred to and implemented in the vehicles 110 so that the vehicles can check whether the conditions thereof are met.

In a step 202, an initial set of safety metrics 124 may also be defined along with appropriate vehicle fleet threshold values. This may also be done by developers 120, for example. The safety metrics with the threshold values are transferred to and implemented on the vehicles 110 so that the vehicles can check whether the threshold values are exceeded or undershot.

In a step 204, the individual vehicles 110 can be made identifiable in the server 100, for which purpose their static data 102 and/or dynamic data 104 can in particular also be stored; these are, for example, so-called digital twins of the vehicles. It is also possible that such data or parts thereof are only retrieved when necessary.

In a step 206, a check is carried out in the vehicles 110 as to whether one or at least one of a plurality of triggering events associated therewith is met. In particular, all existing triggering events are continuously checked as to whether they or their conditions are met. The sensors 114 may be used for this purpose. This is in particular true for each vehicle 110.

In a step 208, a check is carried out in the vehicles 110 as to whether one or at least one of a plurality of safety metrics associated therewith exceeds or falls below a threshold value. In particular, all existing safety metrics are continuously determined or measured. The sensors 114 may also be used for this purpose. This is in particular true for each vehicle 110.

While steps 200 to 204 are in particular preparatory steps, steps 206 and 208 relate to steps continuously carried out during operation of the vehicles 110. It is understood that in a large vehicle fleet, not all vehicles are continuously in operation. Rather, each vehicle can perform steps 206 and 208 when in operation.

Now, if at a time in the vehicle, one or at least one of a plurality of triggering events associated therewith is met and/or one or at least one of a plurality of safety metrics associated therewith exceeds or falls below a threshold value, the operating data 118 of the vehicle present and/or recorded at the time, in particular regarding the triggering event and/or the safety metric, are transmitted by the relevant vehicle 110 in a step 210 to the server 100 or are received there.

For example, the operating data 118 comprise the result of the last sensor self-calibration and the current sensor data for each sensor, internal states, such as the detected environment, current values of all safety metrics, and the triggering triggering event (if applicable). Likewise, they may include the current values of all triggering factors used to determine whether a triggering event is present (speed, position, time of day, weather, etc.).

In a step 212, the server 100 then expediently stores and continuously statistically analyzes the received operating data of the entire vehicle fleet, i.e., of all vehicles 110. The correlations of particularly frequently occurring triggering events and the exceeding or undershooting of threshold values with respect to all measured values or characteristic values are determined.

In a step 214, a list of those triggering events with the largest determined values of the safety metrics may be reported or transmitted to, for example, developers 120 or safety experts since these scenarios appear to be particularly safety-critical.

In a step 216, for the instances of exceeding or undershooting of threshold values, the significant characteristic values (ODD parameters of the situation) can be determined (e.g., speed greater than a certain value, geographic location, night and fog), automatically represented as further triggering events and (optionally after expert review) sent to the vehicle fleet. At the same time, depending on the (human) assessment of the analysis result, the vehicle fleet can also be instructed to proactively avoid risks, e.g., to bypass the inner city during a carnival parade, to drive more slowly, to avoid maneuvers (e.g., overtaking), etc.

In a step 218, since the relationships between the exceeding or undershooting of threshold values and occurring triggering events are statistically known, it can be evaluated for each vehicle individually as to whether it behaves according to the expected distribution of the subset of the fleet with the same configuration. By means of the dynamic data 104 of this vehicle, it is possible to draw conclusions about sensor errors or, for example, incorrect loading. Accordingly, a response, e.g., continuous observation, information to users (e.g., visit to workshop recommended), or direct shutdown can be triggered.

What is claimed is:

1. A method for validating safety precautions for vehicles moving in an at least partially automated manner, based on triggering events and safety metrics, each triggering event defining one or multiple predetermined conditions for one or multiple vehicle parameters and/or environmental parameters detectable at least in part using one or multiple sensors of a vehicle moving in an at least partially automated manner, and each safety metric defining a metric that, in each vehicle moving in an at least partially automated manner, during operation of the vehicle, determines values for one or multiple vehicle parameters and/or environmental parameters and compares them to one or multiple threshold values, the method comprising the following steps:
receiving, from one or each vehicle of a plurality of vehicles moving in an at least partially automated manner, operating data of the vehicle, regarding a triggering event and/or safety metric, present and/or recorded at a time, when, at the time in the vehicle, at least one of a plurality of triggering events associated with the vehicle is met and/or at least one of a plurality of safety metrics associated with the vehicle exceeds or falls below a threshold value;
analyzing the received operating data, and determining correlations of triggering events occurring at more than a predetermined frequency, and/or safety metrics, with respect to static and/or dynamic vehicle data of the one or of the plurality of vehicles moving in an at least partially automated manner; and
providing the determined correlations.

2. The method according to claim 1, wherein new triggering events are determined based on the determined correlations and are transmitted to the one or the multiple vehicles moving in an at least partially automated manner.

3. The method according to claim 1, wherein errors in one or several of the multiple vehicles are determined based on the determined correlations.

4. The method according to claim 1, wherein the static vehicle data include at least one of the following:
vehicle parameters including weight or power or powertrain;
equipment features including LED headlights or active damping or fittings or paintwork;
design parameters including sensor position or sensor and installation direction;
hardware and/or software versions of components of the vehicle.

5. The method according to claim 1, wherein the dynamic vehicle data include at least one of the following:
current weight;
current software version and/or current function version;
current limits of the operational design domain;
set system parameters and/or vehicle parameters;
result of a last sensor self-calibration; and
diagnostic and/or error memory entries.

6. A method for validating safety precautions for vehicles moving in an at least partially automated manner, based on triggering events and safety metrics, wherein each triggering event defines one or multiple predetermined conditions for one or multiple vehicle parameters and/or environmental parameters detectable at least in part by one or multiple sensors of a vehicle moving in an at least partially automated manner, and each safety metric defines a metric that, in a vehicle moving in an at least partially automated manner, during operation of the vehicle, determines values for one or multiple vehicle parameters and/or environmental parameters and compares them to one or multiple threshold values, the method comprising the following steps:
checking, in a vehicle moving in an at least partially automated manner, whether one or at least one of a plurality of triggering events associated with the vehicle is met and/or one or at least one of a plurality of safety metrics associated with the vehicle exceeds or falls below a threshold value; and
transmitting, to an evaluation system, operating data of the vehicle regarding the triggering event and/or the safety metric, present and/or recorded at a time, in particular, when at the time in the vehicle, the one or the at least one of the plurality of triggering events associated with the vehicle is met and/or the one or the at least one of the plurality of safety metrics associated with the vehicle exceeds or falls below a threshold value.

7. The method according to claim 6, wherein the operating data include at least one of the following:
for at least one sensor of the vehicle, a result of last sensor self-calibration and current sensor data;
internal conditions of the vehicle;
current values of at least one safety metric;
the triggering event;
current values of at least one triggering factor used to determine whether a triggering event is met.

8. A computing unit configured to validate safety precautions for vehicles moving in an at least partially automated manner, based on triggering events and safety metrics, each triggering event defining one or multiple predetermined conditions for one or multiple vehicle parameters and/or environmental parameters detectable at least in part using one or multiple sensors of a vehicle moving in an at least partially automated manner, and each safety metric defining a metric that, in each vehicle moving in an at least partially automated manner, during operation of the vehicle, determines values for one or multiple vehicle parameters and/or environmental parameters and compares them to one or multiple threshold values, the computing unit configured to:
receive, from one or each vehicle of a plurality of vehicles moving in an at least partially automated manner, operating data of the vehicle, regarding a triggering event and/or safety metric, present and/or recorded at a time, when, at the time in the vehicle, at least one of a plurality of triggering events associated with the vehicle is met and/or at least one of a plurality of safety metrics associated with the vehicle exceeds or falls below a threshold value;
analyze the received operating data, and determine correlations of triggering events occurring at more than a predetermined frequency, and/or safety metrics, with respect to static and/or dynamic vehicle data of the one or of the plurality of vehicles moving in an at least partially automated manner; and
provide the determined correlations.

9. A non-transitory machine-readable storage medium on which is stored a computer program for validating safety precautions for vehicles moving in an at least partially automated manner, based on triggering events and safety metrics, each triggering event defining one or multiple predetermined conditions for one or multiple vehicle parameters and/or environmental parameters detectable at least in part using one or multiple sensors of a vehicle moving in an at least partially automated manner, and each safety metric defining a metric that, in each vehicle moving in an at least partially automated manner, during operation of the vehicle, determines values for one or multiple vehicle parameters and/or environmental parameters and compares them to one or multiple threshold values, the computer program, when executed by a computer, causing the computer to perform the following steps:
receiving, from one or each vehicle of a plurality of vehicles moving in an at least partially automated manner, operating data of the vehicle, regarding a triggering event and/or safety metric, present and/or recorded at a time, when, at the time in the vehicle, at least one of a plurality of triggering events associated with the vehicle is met and/or at least one of a plurality of safety metrics associated with the vehicle exceeds or falls below a threshold value;
analyzing the received operating data, and determining correlations of triggering events occurring at more than a predetermined frequency, and/or safety metrics, with respect to static and/or dynamic vehicle data of the one or of the plurality of vehicles moving in an at least partially automated manner; and
providing the determined correlations.
